(19) United States
(12) Patent Application Publication
(10) Pub. No.: US 2006/0236119 A1
(43) Pub. Date: Oct. 19, 2006

(54) BIOMETRIC IDENTIFICATION LINKED INTERACTIVE INFORMATION SYSTEM AND METHOD

(76) Inventor: JOSEPH MICHALEL BOBBITT, FLAT ROCK, NC (US)

Correspondence Address: JOSEPH MICHAEL BOBBITT, MD, 215 GREENLEAF DR., FLAT ROCK, NC, 28731, US

(21) Appl. No.: 10/907,835

(22) Filed: Apr. 18, 2005

(51) Int. Cl. H04K 1/00

(52) U.S. Cl. 713/186

(57) ABSTRACT

A biometric identification linked interactive information system and method is disclosed wherein biometric identification scanning is performed by remote mobile, portable and/or fixed device(s). Databases are created at a central (host) unit of biometric identification scans and specific accumulated, individual data and are linked. Remote device(s) may contain sufficient memory storage to maintain active databases relevant to the remote device user; for example, patients on a ward, customers/clients in a store. The central (host) unit may update the remote device(s) and visa versa. Embodiments include any venue where biometric identification and linked information may be desirable: healthcare and commerce; moderate traffic areas of all kinds. Other data may be accessible to the remote device(s) and might be thought of as reference information; for example, pharmaceutical data. In commerce, apparel or any item may be accessible for display on the device, or with torso scan, projected in a “virtual boutique”.

### REFERENCES CITED

U.S. Patents:

| | | | |
|---|---|---|---|
| 6,040,783 | Mar. 21, 2000 | Houvener; Robert et al | 340/5.53 |
| 6,765,470 | Jul. 20, 2004 | Shinzaki; Takashi | 235/380; 340/etc |
| 6,783,459 | Aug. 31, 2004 | Cumbers; Blake | 463/29 |
| 6,839,731 | Jan. 04, 2005 | Alexander; Bruce et al | 709/201 |

U.S. Patent Applications:

| | | | |
|---|---|---|---|
| 20030043042 | Nov. 13, 2001 | Moores, Jr.; John et al | 340/573.1 |
| 20030018522 | Jul. 20, 2001 | Denimarck; Paul | 705/14 |
| 20030105667 | Dec. 3, 2001 | Millikan; Marshall R. | 705/14 |
| 20040078260 | Oct. 22, 2002 | Milgramm; Michael; et al | 705/10 |
| 20050055244 | Jul. 14, 2004 | Mullan; Janet et al | 705/2 |

Other Publications:

“Soon, Marketing Will Follow You” Terdiman, Daniel Wired News Dec. 16, 2003

“A Dance with Technology” Wollen, Hayes, Jr., MD NCMB Forum No. 3 2004

### BACKGROUND OF THE INVENTION

Errors in healthcare have been cause for study on several fronts over particularly the past two decades. 44,000 to 98,000 deaths in U.S. hospitals per year due purely to preventable medical errors were reported in November 1999 by The Institute of Medicine, a subsection of the National Academy of Science (chartered by Congress). A short article by Hayes Wollen, Jr., MD, president of North Carolina's Mecklenburg County Medical Society, reports that “ . . . most medical errors are system-related, and not attributable to individual negligence or misconduct”. For whatever reasons, medical errors are “ . . . 70% . . . preventable”, he goes on to say. The need for improvement in the system of medical delivery is needed, and the present invention, as disclosed in one of the preferred embodiments, helps eliminate or greatly reduce one of the major healthcare error points-inadequate patient specific data at the immediate time of intervention. The RN, doctor, CRNA (Certified Registered Nurse Anesthetist), LPN, X-ray technician, etc do not have needed data or identification verification at hand during the critical intervention point. Some patients/clients are unable, unwilling, or incompetent to identify themselves, ask about interventions, or comprehend relevant facts about the proposed interventions; verification is needed at precisely the point required most the immediate time of intervention. The present invention addresses these problems by biometric identification, and computer database linked patient specific data that provides verification of who the person is, and what intervention is ordered via the caregiver's audiovisual, portable communication device, as disclosed in one of the preferred embodiments.

In the point-of-sale arena and other venues of customer/client and commercial marketing, knowledge is king. It is generally known that Walmart, Inc. grew to its enormous size by excelling in two things: superior inventory control and absolute rock bottom vendor contracts. The current invention creates another bit of information for inventory control and has far reaching applications in merchandising and sales, including internet sales.

The development of accumulated information about specific purchases for unique individuals adds volumes to merchandise marketing and inventory control. The present invention as used in marketing creates such specific individual information which sales associates may use interactively to assist customers/clients. Managers may use the data to develop better inventory that customers/clients buy, or more particularly, what the individuals visiting their stores are looking for to purchase. The databases of information which may be generated by the present invention are almost limitless; the inventor wishes not to limit the scope of the applications of these informational databases by his own experience or imagination.

The prior art is replete with examples of device(s) to biometrically identify security treats, shoplifters, and casino scammers. A device by Cumbers, Blake, U.S. Pat. No. 6,783,459 issued Aug. 31, 2004, tracks casino high rollers in order to reward them with perks and discloses computer software to develop databases; for example, sort-match to identify past experience, and if no prior match, “opens a new file in library”. Elaborate device(s) to control medical machinery are disclosed by Mullan, Janet; et al. in application 2005005244, filed Jul. 14, 2004. Biometric identification is used by Shinzaki; Takashi in U.S. Pat. No. 6,765,470 issued Jul. 20, 2004 to secure use of a portable device. Biometric identification plus shopping history relayed to a terminal is disclosed by Milgramm, Michael in application number 20040078260 filed Apr. 22, 2004; but no biometric identification scanner at remote terminal and neither communication from remote to central unit nor portability disclosed. Similarly, the system by Denimarck, Paul in application 20030018522 filed Jan. 23, 2003 links biometric identification scan to shopping history to reward as does Cumbers, Blake above, but device as shown is not portable, does not have remote scanners, nor discloses communication from remote to central unit. In the same vane, Millikan discloses a message targeting system and method to project advertisements to customers in a store. The advertisements are aimed at the consumer, not the attendant (such as a sales clerk), and specifies “ . . . consumer characteristics pool . . . ”, in other words, generic similarities, to project “ . . . collective audio/video information . . . ” meaning ads aimed at a group with identified similarities “. . . logged in . . . ”. Again, the ads are general in nature projected for the generic customers identified biometrically. Houvener, et al in U.S. Pat. No. 6,040,783 issued Mar. 21, 2000 discloses a system for biometrically identifying legitimate users at remote locations and has developed an audit trail for each use by authorized users. He is not using the remote scanner to identify subjects to obtain data on specific individuals, but as security for the system. Houvener et al is again a security use of biometric identification, not an informational use as in the present invention. Wireless communications are disclosed by Moores, Jr. et al. in application number 20030043042 filed Mar. 6, 2003 and by Alexander, et al. in U.S. Pat. No. 6,839,731 granted Jan. 4, 2005. Moores, Jr. et al also discloses “ . . . portable display device”, but has no biometric scanner on the portable devices. He also uses a “tag” to trigger a biometric scan. Both the lack of biometric scanner at the portable device and the need for a “tag” severely limit the use of Moores, Jr. et al in the context of an informational system as in the present invention.

No one puts all these pieces together to create an interactive biometric identification linked information system as disclosed herein. The present invention as disclosed utilizes biometric identification scanning, but does not elaborate any particular method of scan. This should not limit the invention, but broaden it, because specific applications requiring different techniques to scan individuals biometrically may be warranted, as well as the future development of new methods and device(s) to scan biometrically. The present disclosure implies facial recognition but should not be seen as limited to this technique. The broad scope of the present disclosure is not limited to any particular biometric identification scanning method or device.

### SUMMARY OF INVENTION

The invention utilizes a central (host) unit and remote mobile, portable and/or fixed communication device(s). The central (host) unit contains a computer processor and storage device, and a communications apparatus. A database of biometric identification scanned parameters of individuals is created, as is a database of specific, accumulated, individual data at the central (host) unit. The central (host) unit also contains software to sort-match a particular individual's scan to the database of individuals already scanned to yield a unique individual. Software then links the unique individual just identified to the specific, accumulated individual data of that individual. Remote mobile, portable and/or fixed communication device(s) each contain a biometric identification scanner, a computer processor, a storage apparatus, a communication apparatus linking it to the central (host) unit, and an audiovisual presentation apparatus. The remote communication device(s) may be hard wired between the central (host) unit and each of the remote fixed communication device(s). However, non-wired network links are the preferred means for communication between the remote mobile, portable communication device(s) and the central (host) unit. Whether wired or non-wired, the remote device(s) and central (host) unit communicate with each other; at least, in so far as the remote device(s) relay biometric identification scan parameters to the central (host) unit, and the central (host) unit relays specific, accumulated, individual data to the remote device(s), as disclosed in one of the preferred embodiments. It is one of the major aspects of the present invention that biometric scanning is performed by the remote mobile, portable and/or fixed device(s). The biometric scanner need not be fixed to the remote device(s), but may be connected thereto via non-wired and/or wired means. For example, a facial recognition scanner (camera) may be so small as to be mounted on a lapel or in a small adornment and connected to the remote device via wire. However, the biometric scanner may be far enough away from the remote device that non-wired network connection may be more appropriate; as in the operating room situation mentioned below. Whether the biometric scanner is wired or non-wired, it is “connected” to the remote device(s), and information or data from its scan is used by the remote device(s) or transmitted by the remote device(s) to the central (host) unit.

The invention incorporates a registration of individual biometric identification recognition parameters to create a computer database in a central (host) unit. The individual being scanned may actively or passively participate in this registration process. Specific, individual data is entered to create a database, which becomes specific, accumulated, individual data linked to the individual's biometric identification scan.

In one of the preferred embodiments, healthcare information is the patient/client specific, accumulated, individual data and is entered to create a database of healthcare information at the central (host) unit. The healthcare information may be accumulated over one brief encounter or over many years of encounters. The healthcare information may be loaded from existing computer systems and/or scanned from paper charts into the central (host) unit. Specific healthcare data may include such patient specific data as allergies to medication, anesthesia reactions, current medications used and schedules, log of diagnoses, past surgeries, hospitalizations, treatments, etc. The biometric identification recognition data and the patient specific, accumulated, individual data are linked in the central (host) computer and via network communication the specific accumulated, individual data and/or the image of the patient/client identified biometrically via sort-match software are communicated to the remote, mobile, portable communication device(s) carried by the healthcare givers. Each healthcare giver carries a remote mobile, portable communications device. Each said remote mobile, portable communication device is equipped with a biometric identification scanner, a storage apparatus, a network communication apparatus to communicate with said central (host) database system, a computer processor for processing said biometric identification data and said patient specific, accumulated, individual data and an apparatus to display in audiovisual format at said device the relevant information required by said healthcare giver to provide proper care to said patient that has just been scanned by said remote, portable communication device biometric identification scanner. An earpiece may be worn by each healthcare giver and the patient's name “spoken” by the earpiece after the remote mobile, portable device has scanned and biometrically identified the approached patient. Any of the specific accumulated, individual data or any reference information, as noted below, may be “spoken” in the earpiece if needed or desired. A visual presentation apparatus on the remote mobile, portable communication device(s) would display any of the patient/client specific individual data and/or the image of the biometrically identified individual, if preferred by the user.

Further, other data may be made available to said remote communication device(s) as required by each individual healthcare giver to perform their interventions more safely. Such other data may include medical information; for example, a detailed description as from a nursing textbook of how to administer a particular intervention, or whatever data the healthcare giver may need. Other information may include reference data, steps to perform an intervention, or any assortment of information deemed needed by the attending healthcare giver, or user of the remote mobile, portable and or fixed device(s).

When the healthcare giver approaches or interacts with a patient whose biometric identification data and patient specific, accumulated, individual data have been previously entered in said databases: 1—said biometric identification scanner acquires said patient biometric parameters and either internally sort-matches the scanned data to its internal active [explained below] biometric database or communicates the just scanned biometric parameters via network communication link to the central (host) computer unit where sort-match is preformed against the central (host) unit's biometric identification database. In either case, sort-matching of the patient just biometrically scanned is performed which results in the identification of a unique individual; 2—results of said sort-match patient identification is linked to said patient specific, accumulated, individual data (again by either the central (host) unit or by the remote, portable device if so equipped) of that individual just identified; 3—the specific, accumulated individual data and/or image of the patient/client biometrically identified are relayed via wired and/or non wired communication network, to the remote mobile, portable and/or fixed device (it being understood that if both databases are internal to the remote mobile and/or fixed communication device(s), this step is not needed except to update internal databases); 4—the individual patient in front of the healthcare giver is identified by name, and by image (as by picture) if needed for verification and/or for further safety in identification, and presented to the remote, mobile, portable communication device via earphone and/or visual presentation apparatus; 5—the presentation via audiovisual apparatus of said patient specific, accumulated, individual data on the communication device may be programmed in such a manner as required by each individual healthcare giver, or as any group of similar healthcare givers; for example, CRNAs may need a different grouping of patient specific, accumulated, individual data than would say a ward nurse. The linked information of the patient in front of you with the information you specifically need at exactly the intervention point and in a format most usable by the healthcare giver adds safety and protection heretofore unavailable interactively prior to the present invention. Time consuming physical chart review or computer chart review has led to the errors and deaths noted previously. A better method and apparatus is disclosed. Biometric scanning mobility coupled with biometrically linked information as disclosed in the current invention is different from any prior art use of biometric identification.

In one embodiment, a medication technologist or nurse comes to give medication to an individual patient. His/her mobile, portable biometric scanner scans the patient in front of him/her, sort-matches and identifies the individual patient just scanned, then retrieves relevant patient specific, accumulated, individual data and/or the image of the patient/client biometrically identified from either the mobile, portable communication device or from the central (host) computer, and displays in audiovisual means, and formatted to the specific information needed by said medication technologist. The image of the biometrically identified patient/client displayed on the remote mobile, portable communication device adds another safety measure. The medical technologist compares the display image to the person in front of him/her for verification. A further refinement of this embodiment includes means to access relevant other information that may more completely assist the safety feature of the present embodiment. Other information that may be needed includes, but should not be construed as limiting the broad scope of the present invention, access to pharmaceutical data. Usual dosages, pictures of the specific medication to be given, side effects, interactions, etc may be made available to the medication technologist or nurse.

In yet another embodiment, intervention orders would be displayed on the mobile, portable communication device for the individual patient in front of the health care giver. There is neither a physical chart carried to the bedside by the healthcare giver nor computer terminal in the room which needs to be searched or reviewed prior to the encounter with the patient. All relevant information is available to the healthcare giver via the mobile, portable communication device carried and checked by said health care giver prior to intervention. The complaint by healthcare givers that computers require attention away from direct care of the patient could be overcome by audio presentation of relevant patient specific accumulated individual data needed by the healthcare giver. Presentation formatting of just information the healthcare giver needs should overcome the complaints.

Because of the vast expansion in internal memory and speed of processors available in handheld device(s), a further embodiment of the present invention provides for two way communication between the central (host) unit and the remote, portable and/or fixed device(s) such that databases in either may be updated. That is to say, the remote mobile, portable and/or fixed device(s) may update the central (host) computer database of patient (or customer/client) specific, accumulated, individual data and/or the database of biometric identification data. Likewise, if the remote, portable and/or fixed device(s) are so equipped, the central (host) unit may update the database(s) in the remote, portable and/or fixed device(s). It is understood, that the database(s) in the remote mobile, portable and/or fixed device(s) need not be identical to the central (host) unit databases. For ease of following, we might call the databases in the remote devices “active”; meaning, that these remote device(s) may contain only that part of the central (host) unit's comprehensive database which is actively used by each of the remote device(s). Likewise, both an active biometric identification database and an active specific accumulated, individual database may reside in the remote device(s). These then are the partial databases to be updated by the central (host) unit.

In another embodiment of the current invention, a biometric scanner is mounted at each entrance to operating rooms at a surgery department. As each patient is wheeled into each surgery suite, the said biometric scanner captures said patient individual biometric features, sort-matching identifies said individual patient, then relays patient specific, accumulated, individual data and/or biometrically identified patient image to audiovisual means in said operation suite, and formatted in a manner needed by attendants in said operating suite to properly care for said individual patient.

The present invention is applicable to any environment where positive individual biometric identification and linked specific, accumulated, individual data may be used or stored for use immediately, soon, or in the future. Mobile, portable communication device(s) may also update their internal databases and/or the central (host) computer databases and/or visa versa.

Another primary embodiment of the present invention is in consumer marketing. Biometric identification via active or passive participation of each individual customer/client with linked activity is used to access both what items bought, and accumulated to create a history of purchases as well as items customers examine, try on and refuse. Each sales associate carries a mobile, portable biometric scanner, network linked communication device with audiovisual means to display relevant information about customer/client standing in front of them. The biometric scanner captures biometric features of said customer/client then sort-matching is performed by the mobile, portable communication device or by the central (host) computer. Relevant customer/client specific, accumulated, individual data are linked internally in said mobile, portable communication device or relayed by said network communication link from said central (host) computer database. Audiovisual means display relevant information on said mobile, portable communication device for use by said sales associate to facilitate sales or assist the customer/client. Tracking of individual customers/clients may be used to assist the marketability of merchandise when sales associates “know” via network linked communication device(s) carried by said associates, what items the individual customer/client likes, has bought in the past, or whatever information management deems needed by the sales associates to help customers/clients buy. The remote mobile, portable device(s) may use an earpiece to “speak” the customer/client's name after the biometric scan has identified the customer/client. Other specific, accumulated individual data may be “spoken” by the earpiece as needed for the sales associate to improve sales or assist the customer/client. Biometrically identified customer/client image and specific accumulated individual data may be displayed on visual presentation apparatus as well.

In another embodiment, scanners mounted above departments monitor activity of customers/clients below to ascertain what items customers buy as well as items customers examine, try on but refuse. In this embodiment of the invention, retail establishments mount biometric scanners over items of merchandise, recording individual shoppers who spend time examining specific merchandise but who refuse purchase. Refused merchandise would be recorded, analyzed and patterns developed to improve ordering to avoid costly inventory revenue losses. Merchandise purchased would be monitored as well.

Yet another embodiment takes the above customer/client tracking one step further; to wit, a torso biometric scan is performed on each customer/client; via audiovisual means, the individual customer/client's torso is projected onto a screen (for example, plasma screen, CRT, or video projection device); items of interest to the customer/client are projected onto the customer/client's torso projection and exhibit the effect of the item of interest “on” the customer/client. For example, the customer is interested in a purchasing a blouse. A biometric torso scan is performed on the customer/client. The identified blouse is projected onto the customer/client's projected torso image, giving the effect that the blouse is “on” the customer/client. Multiple colors, sizes and fabrics are may be displayed on the projected torso image until the customer/client chooses the blouse she will purchase. Complimentary accessories and other clothing apparel may be projected onto the torso projection via audiovisual means.

The present embodiment has the extension of shopping on the internet via a “virtual boutique”. In this embodiment, your torso scan would be projected onto your internet-connected screen in an assortment of attire until your order was finalized. The items purchased would be made to order from your specifications or delivered off the rack. The future “store” would have no inventory, no sales force, and no inventory losses.

One final embodiment of the “virtual boutique” would be an actual, physical store containing only swatches of material to be chosen, since feel plays an important roll in the buying of clothing. In this venue, material would be available to feel and “try” prior to purchase.

The method of performing biometric identification scans at remote mobile, portable and/or fixed device(s), developing databases of these scans as well as developing databases of specific, accumulated, individual data and linking these data to unique individuals may be gleaned from the foregoing disclosure. The method includes the following steps:

1—the step of biometric identification scanning by remote mobile, portable and/or fixed device(s);

2—the step of communicating the biometric identification scan to a central (host) unit;

3—the step of creating a database of these biometric identification scans;

4—the step of creating a database of specific accumulated, individual data of individuals scanned;

5—the step of sort-matching a particular individual's biometric identification scan with the database of biometric identification scans to yield a unique individual;

6—the step of linking the unique individual identified by the sort-match with his/her specific, accumulated, individual data;

7—the step of communicating the specific, accumulated, individual data from the central (host) unit to the remote mobile, portable and/or fixed device(s); and

8—the step of storing, processing, and/or presenting the specific accumulated, individual data by the remote mobile, portable and/or fixed device(s), on audiovisual means the unique individual biometrically identified.

It is further understood from the above disclosure that steps 3-6 may be performed by the remote mobile, portable and/or fixed device(s), if so configured. That is to say, the remote mobile, portable and/or fixed device(s) may perform the steps of database creation, storage, sort matching, and linking. Likewise, creation of the databases may be at the central (host) unit and updated to the remote device(s). Also, the central (host) unit may contain all of the data of both databases, and only update the separate remote device(s) as each user of that device requires; that is, as much or as little as needed. Finally, it is further understood that the central (host) unit may communicate via wired and/or non wired means the biometric identification data of the individual biometrically identified to the remote mobile, portable and/or fixed communication device(s) such that the user may verify that the biometrically identified individual is in fact the person in front of him/her; that is, another safety feature. Therefore, a 9^{th} step would verify that the biometrically identified individual is in fact the individual that was just biometrically scanned.

### DESCRIPTION OF DRAWINGS

FIG. 1 shows a schematic view of the basic invention. The communication link is purposely not identified, since both wired and non wired connections are envisioned.

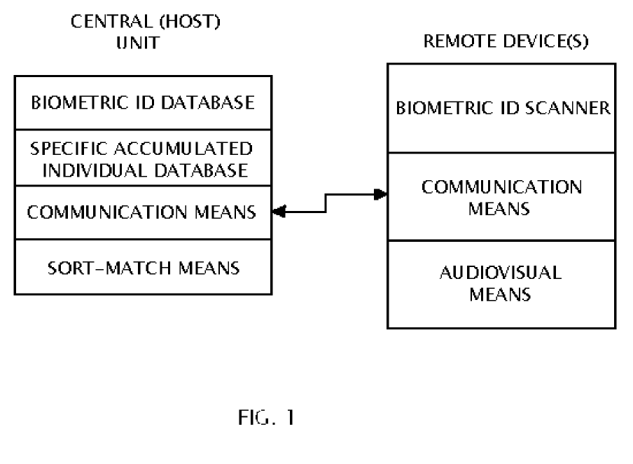

FIG. 2 shows the addition of a processor and storage means in the remote mobile, portable and/or fixed device(s).

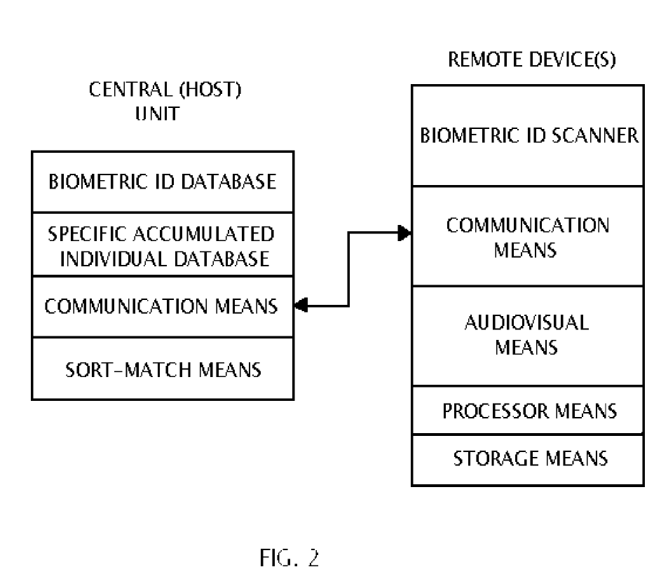

FIG. 3 shows the biometric identification scanner apart from the remote device(s) to illustrate that the biometric scanner need not be physically part of the remote device(s). The remaining drawings show the biometric scanner in this configuration.

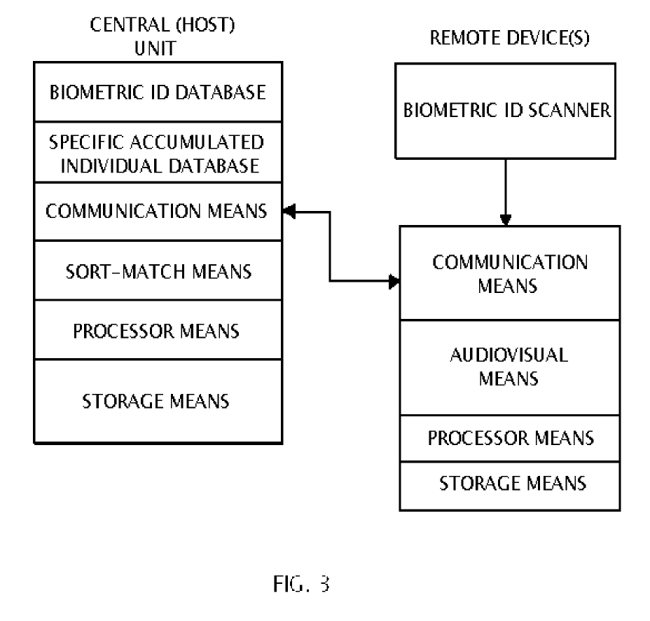

FIG. 4 represents both storage means and processor means at the central (host) unit and the remote mobile, portable and/or fixed device(s); plus a database of active specific accumulated individual data at the remote device(s).

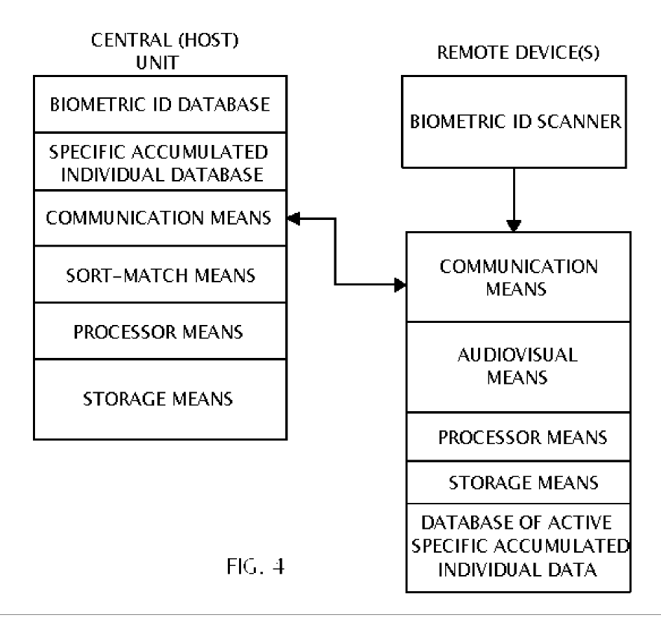

FIG. 5 adds to FIG. 4 at the remote device(s) an active database of biometric identification data and the means to determine a unique individual scanned; that is sort-match means.

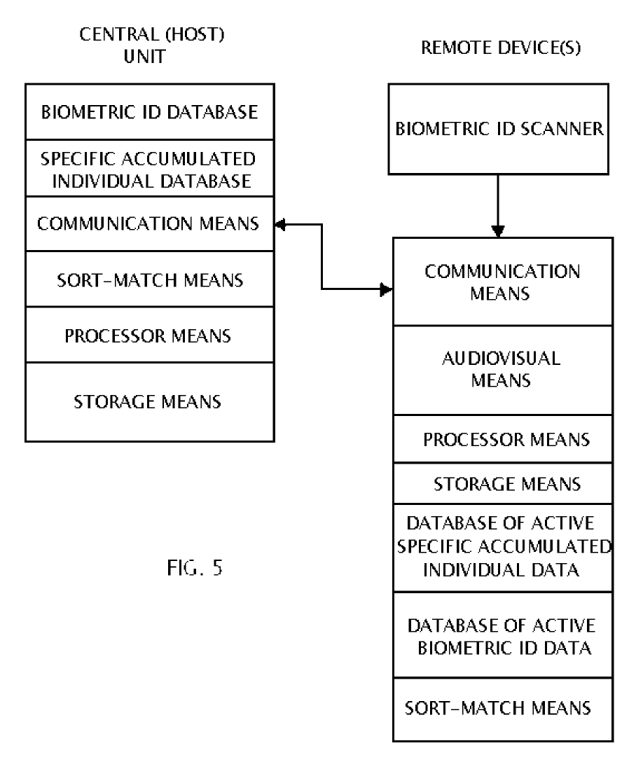

FIG. 6 adds to FIG. 5 the identification that healthcare information is the specific accumulated individual data being used.

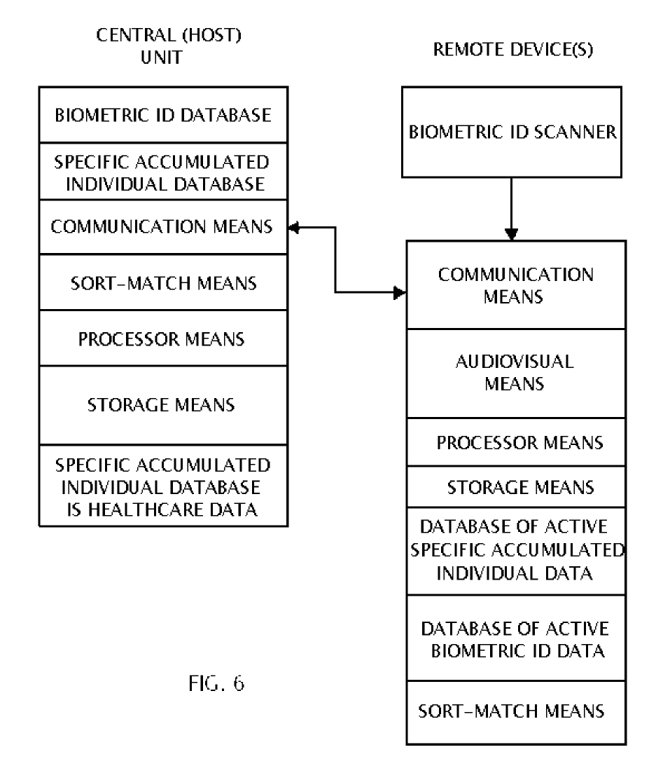

FIG. 7 adds to FIG. 5 the identification of customer/client information are the specific accumulated individual data being used.

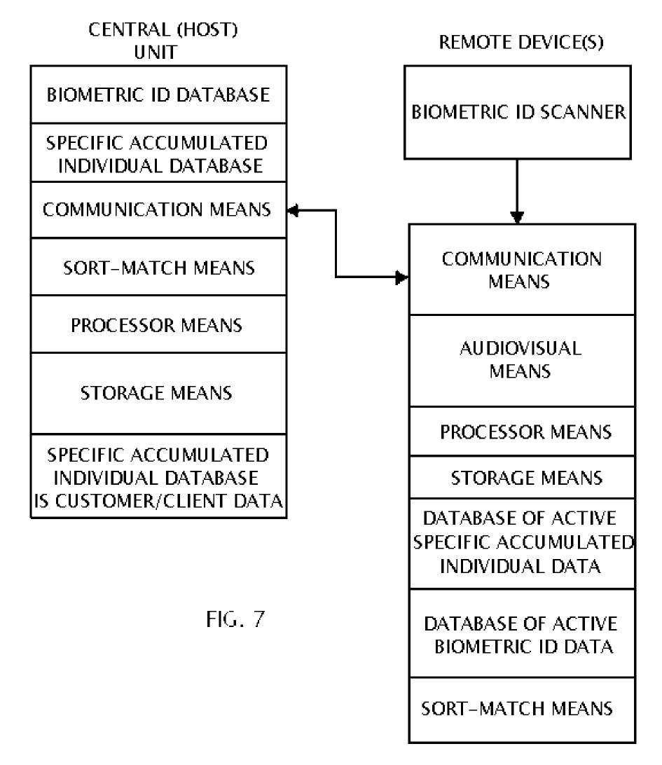

FIG. 8 adds to FIG. 5 other data may be accessed and displayed.

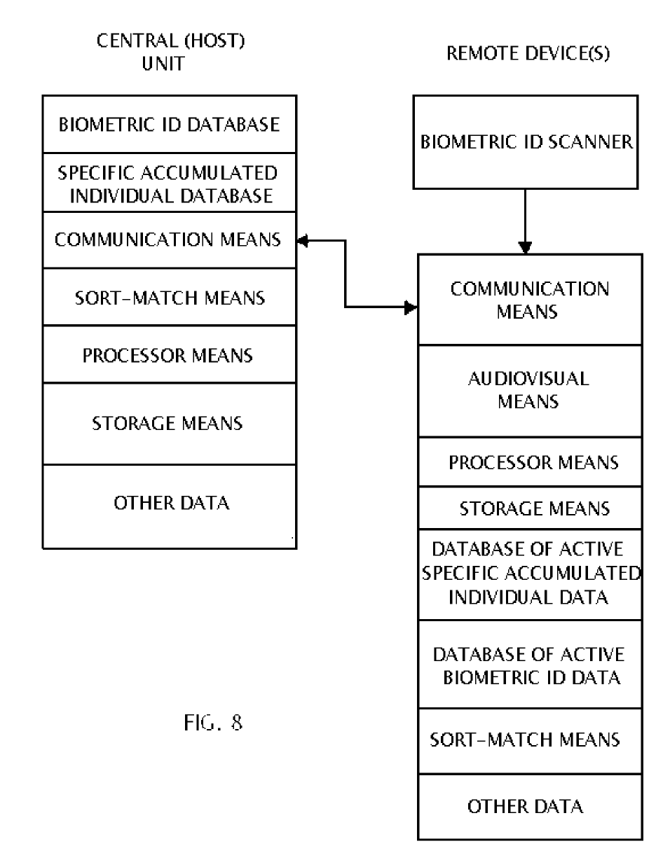

What is claimed is:

1. A biometric identification linked interactive information system including: 1) central (host) unit containing: A) biometric identification database, B) specific, accumulated, individual database, C) sort-match means to determine unique individual scanned, D) communication means; and 2) remote mobile, portable and/or fixed device(s) containing: a) biometric identification scanner; b) communication means; and c) audiovisual means.

2. A biometric identification linked interactive information system of claim 1, wherein said remote mobile, portable and/or fixed device(s) contain storage means for storing active specific, accumulated, individual database and/or specific, accumulated, individual data.

3. A biometric identification linked interactive information system of claim 1, wherein said remote mobile, portable and/or fixed device(s) contain storage means for storing active biometric identification database and/or biometric identification data.

4. A biometric identification linked interactive information system of claim 3, wherein said remote mobile, portable and/or fixed device(s) contains sort-match means to determine unique individual scanned by said remote mobile, portable and/or fixed device(s).

5. A biometric identification linked interactive information system of claim 1, wherein said remote mobile, portable and/or fixed device(s) contain storage means for storing both active specific, accumulated, individual database and/or specific, accumulated, individual data and active biometric identification database and/or biometric identification data.

6. The biometric identification linked interactive information system of claim 1, wherein said remote mobile, portable and/or fixed device(s) update the central (host) database(s) of specific, accumulated, individual data and/or biometric identification data.

7. The biometric identification linked interactive information system of claim 1, wherein said central (host) unit updates the remote mobile, portable and/or fixed device(s) database(s) of active specific, accumulated, individual data and/or biometric identification data.

8. The biometric identification linked interactive information system of claim 1, wherein said remote mobile, portable and/or fixed device(s) communicate with said central (host) computer via wired and/or non-wired means.

9. The biometric identification linked interactive information system of claim 1, wherein said remote mobile, portable and/or fixed device(s) contain storage means and processor means to store, process and/or display the image of the individual biometrically identified and/or specific, accumulated, individual data.

10. The biometric identification linked interactive information system of claim 1, wherein said specific, accumulated, individual data are healthcare data.

11. The biometric identification linked interactive information system of claim 1, wherein said remote mobile, portable and/or fixed device(s) contain storage means and processor means to store, process and/or display specific, accumulated, individual data and such other data as needed by said user(s) of said remote mobile portable and/or fixed device(s).

12. The biometric identification linked interactive information system of claim 11, wherein said other data are reference data not unique to the specific individual biometrically identified.

13. The biometric identification linked interactive information system of claim 11, wherein said other data are pharmaceutical data.

14. The biometric identification linked interactive information system of claim 1, wherein said specific, accumulated, individual data are customer/client data.

15. The biometric identification linked interactive information system of claim 1, wherein said specific, accumulated, individual data are customer/client data; and such other data as needed by said user(s) of said remote mobile portable and/or fixed device(s).

16. The biometric identification linked interactive information system of claim 15, wherein said other data are commercial item data.

17. The biometric identification linked interactive information system of claim 14, wherein said specific, accumulated, individual data includes a torso scan of the individual customer/client.

18. The biometric identification linked interactive information system of claim 17, wherein said other data are apparel data; said torso scan is projected onto a visual imaging means; and said apparel data is projected onto the said torso projection by audiovisual means.

19. The biometric identification linked interactive information system of claim 18, wherein said other data are apparel data and/or accessory data; said apparel data and/or said accessory data are projected onto said torso scan projection by audiovisual means.

20. A method of interactive communication linking biometric identification to specific, accumulated individual data utilizing the step of biometric identification scanning by remote mobile, portable and/or fixed devise(s); the step of communicating via wired and/or non-wired means the scanned biometric identification data captured by said remote mobile portable and/or fixed device(s) to a central (host) unit; the step of creating a database of biometric identification data at said central (host) unit; the step of sort-matching of scanned biometric individual data with said biometric identification database to yield a unique individual; the step of creating a database of specific, accumulated, individual data at said central (host) unit; the step of linking specific, accumulated, individual data to the unique biometrically scanned individual; the step of communicating via wired and/or non-wired means from the central (host) computer to said remote mobile, portable and/or fixed devise(s) said specific, accumulated, individual data and/or image of the individual biometrically identified; the step of storing, processing, and/or presenting on audiovisual means by said remote mobile, portable and/or fixed devise(s).

21. The method of claim 20 wherein said remote mobile, portable and/or fixed devise(s) includes the step of storing within the remote device(s) a database of active specific, accumulated, individual data.

22. The method of claim 20 wherein said remote mobile, portable and/or fixed devise(s) includes the step of storing within the remote device(s) a database of active biometric identification data and the step of sort-matching of scanned biometric individual data with said active biometric identification database to yield a unique individual.

23. The method of claim 20 wherein said remote mobile, portable and/or fixed devise(s) includes the step of storing within the remote device(s) a database of active specific, accumulated, individual data; the step of storing a database of active biometric identification data; and the step of sort-matching of scanned biometric individual data with said active biometric identification database to yield a unique individual.

24. The method of claim 20 wherein said remote mobile, portable and/or fixed devise(s) includes the step of presenting via audiovisual means the biometric identification data and/or specific, accumulated, individual data and/or image of the individual biometrically identified.
